(19) United States
(12) Patent Application Publication
(10) Pub. No.: US 2024/0089830 A1
(43) Pub. Date: Mar. 14, 2024

(54) GATEWAY CONNECTION FROM BEACON TRACKERS TO A NETWORK

(71) Applicant: COLDCHASE GP INC., Edmonton (CA)

(72) Inventor: Ken BRIZEL, Edmonton (AB)

(21) Appl. No.: 18/263,873

(22) PCT Filed: Feb. 4, 2022
(86) PCT No.: PCT/CA2022/050162

§ 371 Date: Aug. 1, 2023

Related U.S. Application Data
(60) Provisional application No. 63/146,133, filed on Feb. 5, 2021.
(60) Provisional application No. 63/201,868, filed on May 17, 2021.

(51) Int. Cl. H04W 48/10; H04W 48/16

(52) U.S. Cl. CPC H04W 48/10; H04W 48/16

(57) ABSTRACT

A tracking system includes sensor beacons which include sensors to gather environmental data and a communication module configured with a short range wireless communication protocol, and gateways which are connected to a remote server via the Internet, which automatically connecting via the short range wireless communication to sensor beacons when a sensor beacon comes within range. The gateways receive data from the sensor beacon and relay the sensor beacon identity and data to the remote server.

### FIELD OF THE INVENTION

The invention relates to systems, methods, and program products for communication with and localization of tracking beacon sensors globally.

### BACKGROUND OF THE INVENTION

The ability to track and transmit location and sensor data for logistics and transportation of goods worldwide today is extremely important for security of products and materials, particularly in the food and drug industries.

Tracking units typically comprise many sensors, processors, memory and a cellular or satellite communication link to the Internet. Transportation and logistics companies use these tracking units to track their shipments worldwide. The cost of these tracking units are quite expensive due to the communications links for each individual tracker. Satellite communication can be prohibitively expensive. Further, issues can arise because cellular network connectivity can vary from country to country.

There is a need in the art for cost-effective solutions and services for gathering and communicating information about a shipment, particularly in view of the huge increase in transportation of sensitive goods worldwide.

### SUMMARY OF THE INVENTION

Systems, methods, devices and program products are provided for communication with and localization of tracking sensor beacons. In some embodiments, the invention provides tracking on a local, national, or even global scale.

In general terms, the invention comprises a system for environmental sensing of a shipment, comprising a sensor beacon and a gateway. A sensor beacon may comprise at least one sensor for measuring environmental data, a memory for storing the measured data, and a communication module for wirelessly communicating with the gateway via a short-range wireless platform, such as LoRa, Bluetooth, or WiFi. A gateway comprises a communication module for wirelessly connecting to a sensor beacon and for communicating with a remote server via the Internet, and is configured to receive environmental data from the sensor beacon and transmit such data to the remote server.

The sensor beacon may be attached to or included with a shipment of goods and will track the shipment by connecting to at least one gateway between the origin and destination of the shipment. The sensor beacon connects automatically with a gateway when it is within the range of the gateway wireless communication platform. Upon connection, the sensor beacon will confirm its identity, allowing confirmation of the shipment progress, and transfer to the gateway any available environmental data that the sensor beacon may have stored to that point.

In some embodiments, the sensor beacon communication module may comprise an FM transmitter which will transmit data short range (eg. less than about 100 ft). In this system, the gateway may comprise a FM receiver which is configured to receive the data and transmit such data to the remote server. In one embodiment, the gateway comprises a smart phone configured with an app which detects and receives FM data transmissions from the FM transmitting sensor beacons. The smart phone may be carried about to detect and connect with sensor beacons.

### BRIEF DESCRIPTION OF THE DRAWINGS

In the drawings, which form part of the specification, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 shows a schematic representation of the sensor beacon and gateway connection with a remote server through the Internet.

FIG. 2 shows schematic depictions of the sensor beacon and the gateway.

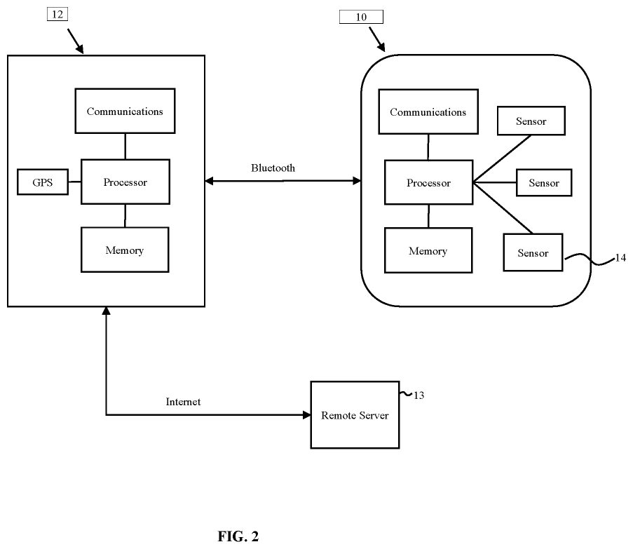

FIG. 3 shows a schematic representation of one embodiment of an FM radio transmitter tag and a receiver.

### DETAILED DESCRIPTION OF EMBODIMENTS OF THE INVENTION

In some aspects, the invention relates to computer-implemented systems, methods, and program products for sensor beacon tracking. Any term or expression not expressly defined herein shall have its commonly accepted definition understood by a person skilled in the art.

System of the Present Invention

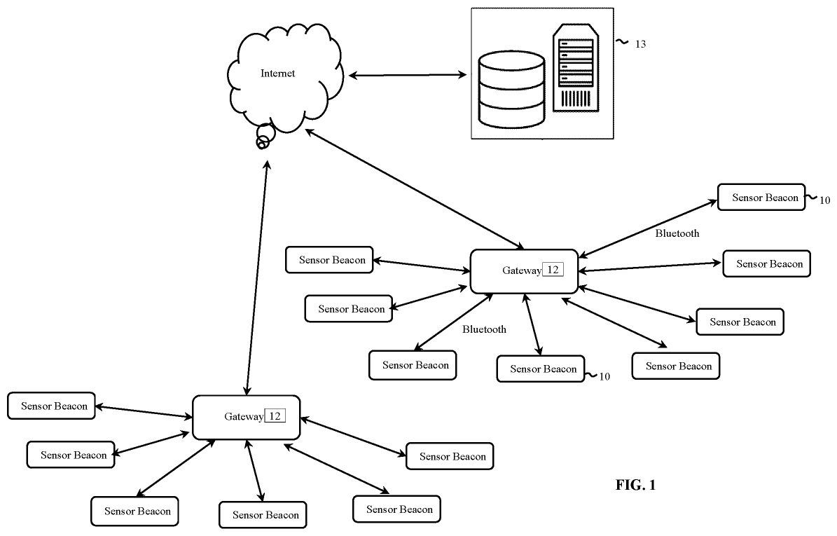

FIG. 1 shows a schematic depiction of an embodiment of a system of the present invention including sensor beacons (10) and gateways (12). The system may comprise a computer server system (13) which communicates with a plurality of gateways (12), strategically located in the intended transportation path, which are configured to communicate with a plurality of uniquely identifiable sensor beacons (10).

“Tracking”, as used herein, means the process of determining the location of a shipment over time. As the sensor beacons of the present invention collect environmental data, tracking also includes determining environmental conditions of the shipment as it is being transported.

A sensor beacon (10) may be included with or attached to a shipment of goods, which is being transported in any conventional manner, such as by truck, rail, ship, or air. A gateway (12) may be installed in a tracking location between the shipment origin and destination, and may be a permanent or stationary installation, or may be a portable device, such as a handheld device, such as a smartphone. A gateway may be mounted on mobile equipment, such as a forklift or other vehicles or machinery which are used to handle or move a shipment. Exemplary locations for the gateway include any freight terminal or facility where a shipment may physically pass through.

A sensor beacon (10) includes one or more sensors (14) to gather environmental data, which may include temperature, humidity, atmospheric pressure, air quality, accelerometer for measuring shock and/or vibration, a light sensor, an image sensor (camera), and/or a gas sensor (for example CO, CO₂, H₂S, O, H gas sensors), or various combinations of such sensors. The sensors are connected to a processor and a memory, which gathers and stores the data provided by the sensors. Different sensors may be programmed to provide data on a different basis. For example, in some embodiments, the temperature and pressure sensors may take and store readings on a periodic basis, such as once per minute. The sampling rate may be dependent on battery life and on memory storage capacity. Additionally or alternatively, a sensor maybe programmed to take a reading periodically and store data readings only upon certain parameters being met or exceeded. For example, an air quality sensor may sample air quality periodically, but only store data if the measured air quality falls outside an acceptable range. Other sensors may have threshold sensitivity, such as an accelerometer that is only responsive to accelerations which are indicative of abnormal or unacceptable shock or vibration levels. The sensors may be programmed to read and store data more frequently if certain conditions are sensed, for example, if any data parameter exceeds a predetermined value. The sensors may be linked to each other such that, for example, a certain sensor may take and/or store a reading if another sensor has indicated a certain threshold has been met.

In some embodiments, at least one sensor (14) may be a camera and the sensor beacon (10) is configured to take a photograph periodically, or upon certain conditions being met. For example, the camera may be combined with a motion detector and configured to take a picture upon detection of motion, such as a person walking by or moving towards the sensor beacon. In another example, the camera may be combined with a light sensor and configured to take a picture upon a certain light level being reached, such as that indicative of a container which contains the sensor beacon being opened. The resulting digital images may be treated and transferred in like manner to the environmental data collected and stored by the sensor beacon.

The sensor beacon (10) memory may be sufficiently sized to store all the data that it is expected to store during a transport schedule. Alternatively, the data stored by the sensor beacon may be deleted after transfer to a gateway (12) to ensure sufficient storage space for additional data.

The beacon may be powered by a conventional replaceable or rechargeable battery. In some embodiments, a nickel metal hydride rechargeable battery may be preferred, as they have better performance at lower temperatures than alkaline batteries, and are not as restricted as lithium based rechargeable batteries, which may pose a fire risk and may not be allowed in airplanes.

The sensor beacon (10) also comprises a communications module, which is operative to implement a short-range wireless communication platform or protocol, such as Bluetooth, LoRa, WiFi, or any other suitable system. In preferred embodiments, the sensor beacon does not include satellite geolocation (GPS or GNSS) capability. Although location of the sensor beacon may be important, location data is provided by the gateway (12) to which the sensor beacon connects, as described below.

The sensor beacon transmission may include a unique identifier, such as the beacon MAC address, which will be part of the data transmitted to the gateway or the remote server. In some embodiments, the sensor beacon may also have unique identifying information marked in a machine-readable format, such as an optical code, for example a QR code displayed on an exterior surface. A gateway with a camera, such as a smartphone, may then be configured to use its camera module, scan the optical code and confirm the beacon identity. This supplemental identity code may be useful to confirm existence and identity of the beacon in a scenario where multiple beacons may be transmitting within range of the receiving gateway.

In some embodiments, a tracking method may commence with a user or device scanning the QR code, optionally labelling the sensor beacon with a nickname, and associating the sensor beacon identity with the shipment details in the system. In some embodiments, a QR code of a sensor beacon may be sent to a portable gateway (eg. smartphone), which is configured to then detect and identify that beacon only, permitting location of a specific beacon where there may be multiple beacons within a facility.

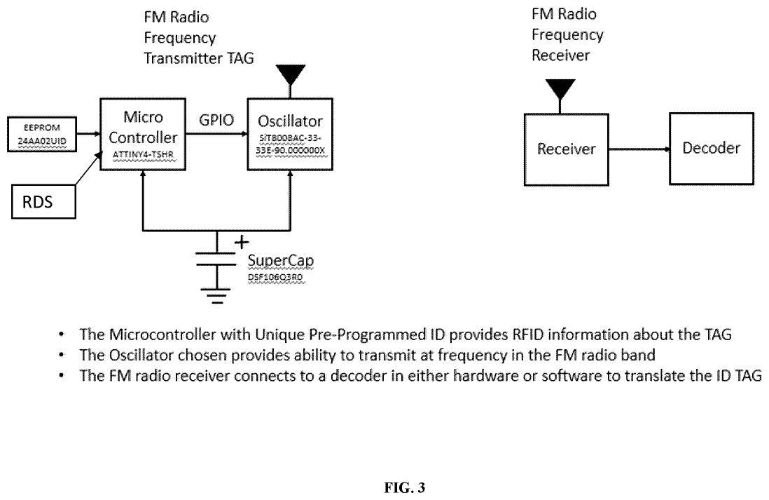

In some embodiments, the sensor beacons may communicate to a gateway sensor using FM radio transmissions, in addition to or instead of another short range wireless protocol, such as Bluetooth™. In this embodiment, the sensor beacons comprise short range FM transmitting tags, as shown schematically in FIG. 3. Devices may operate unlicensed on the AM and FM radio broadcast bands for some extremely low powered devices covered under Part 15 of the United States Federal Communication Commission (FCC) rules. On FM frequencies, these devices are limited to an effective service range of approximately 200 feet (61 meters).

In some embodiments, the FM tags comprise small FM transmitters which will transmit tag information a short range, for example less than about 100 ft. The FM tags may be powered by conventional batteries, which may be rechargeable, or small super capacitors. The FM tag may comprise a small, inexpensive microcontroller used to create the tag identity and to control transmission of the signal. The transmitted signal may be coded to uniquely identify the tag.

In some embodiments, the tags may be configured to transmit a signal on a set FM frequency within the FM band. As used herein, the FM band falls within the VHF part of the radio spectrum, usually 87.5 to 108.0 MHz is used, however, it is noted that in some countries the lower end may be about 65 MHz.

FM tags may be charged and attached to any article, such as a parcel or box which will be transported to another location. Detection of the FM signal by a receiver allows confirmation of the location of a shipment including the tag. In some embodiments, the FM signal does not include environmental data, only the unique identity of the tag. However, in some embodiments, optionally, the FM tag may include a chip or module which is configured to embed digital information into the transmission, such as a Radio Data System (RDS) chip.

A gateway (12) may comprise a processor, a memory and a communications module, which is configured to connect to a remote server (14) via a network, such as the Internet, via any suitable wired or wireless connection, such as conventional TCP/IP or cellular platforms. The communication module is further configured to connect with a sensor beacon, with the short range communication platform, when the sensor beacon comes within range. Upon connection to a sensor beacon, the beacon's stored data may be automatically transferred to the gateway and then transferred or redirected to the remote server. As well, the gateway will read the sensor beacon identifier and transmit to the remote server the beacon identity, along with a time stamp and gateway location.

The gateway (12) may be in a fixed geographic location or may be a mobile device. In preferred embodiments, the gateway includes a GPS module for determining its geolocation, which is reported along with beacon data to the remote server. In some embodiments, the gateway is associated with a single geolocation in the system, if the gateway is in a fixed location.

In some embodiments, the gateway may comprise a “smartphone”, taking advantage of the mobile telephone and computing functions combined into one device. Smartphones can connect to the Internet with cellular data or by WiFi. Portable computers such as laptops or tablets may also be used effectively with WiFi, and without cellular network connectivity.

Where a sensor beacon comprises an FM tag, the gateway may comprise any FM receiver, which may be positioned to screen the FM tags as they pass by, such as a conveyor or other transportation checkpoint. In another embodiment, the gateway may comprise a portable FM receiver. In either case, the FM receiver is configured to receive the FM tag transmission and help locate the tag, such as within a warehouse. It may not be necessary to transmit data to a remote server. In one embodiment, the gateway comprises a smart phone configured with an app which detects and receives FM data transmissions from the FM transmitting sensor beacons. The smart phone may also be configured to use its cellular network or WiFi connectivity to connect to the Internet and transmit the signal to the remote server.

In some embodiments, the gateway may be configured to determine relative strength or power level of a signal received from a sensor beacon, which may permit localization of the sensor beacon. The power level of the transmission may be correlated to approximate distance. Direction of the sensor beacon may be determined by moving the gateway towards a direction resulting in greater signal strength (or away from a direction resulting in lower signal strength).

In some embodiments, signal strength may be correlated with other data. For example, temperature zones in a container or facility may be verified or determined by a strategically located gateway and estimated distances to certain sensor beacons.

In some embodiments, the gateway may be configured to only connect to and receive data from a sensor beacon, and redirect the data to a remote server (14). While the gateway may have other computing or communication capabilities, no data manipulation or analysis need take place prior to receipt of the data by the remote server.

The remote server (14) may be any conventional computing device which can communicate with the gateway (12) to receive and/or store data. The remote server may be configured with software which confirms the sensor beacon identity, matches it to a shipment of goods, and provide geographic localization, based on the location of the receiving gateway which received the beacon's signal. The signal may also be time and date stamped.

In some embodiments, the remote server may be configured with analytical tools allowing a user to analyze the data which is being collected by the sensor beacons and transmitted to the remote server through the gateways. A graphical interface may display the current location of a particular beacon or beacons and the path taken to that point. Anomalous environmental sensor readings may be displayed by location and/or date and time. The system may be configured to alert users to location progress and/or anomalous data by text message or email.

The data analysis tools may comprise any analytical capability. For example, data from multiple beacons may be compiled and analyzed for different purposes. Data from a single beacon may be charted over time and/or by location. In some embodiments, the data may be used to assist in maintenance of facilities and vehicles. For example, evidence of temperature variations may be used to indicate required maintenance or repairs to HVAC equipment. The system may use machine learning or artificial intelligence modules in different ways. For example, more efficient or quicker, safer or otherwise more desirable shipping routes may be identified. Required or desired maintenance of shipping equipment may be predicted using the data acquired from the sensor beacons.

### Embodiments of Methods of the Present Invention

A sensor beacon may be included or attached into a shipment of goods for which tracking data is desired. As the shipment is being transported, the sensor beacon will collect and store data as described above. When the shipment passes through the proximity of a gateway, it will connect to the gateway and transfer its identifying data and/or any sensor data which has been stored.

The gateway will then transmit the sensor beacon identity and data to the remote server, where it can be accessed, processed and/or analyzed by a user. The user may be a remote operator, or may comprise programs or logic which are initiated by the receipt of the data.

A large number of sensor beacons and gateways may be deployed in a system, which permits a user to track many shipments regardless of origin or destination, provided that the gateways are strategically placed.

### Example 1

The specifications of an exemplary sensor beacon may be as follows:
Dimensions: 125 mm×70 mm×24 mm
Weight: 116 g (including batteries)
ABS plastic case, IP40, UL94 HB
Available Sensors:
   Temperature, NIST traceable, ±0.1° C., the operating range of −40° C. to +80° C. can optionally replace with a T-type thermocouple (±1° C.) for remote measuring temperatures of −100° C. to +80° C.
   Humidity, ±3% RH from 0 to 100%
   Atmospheric Pressure, 0.12 Pa RMS noise (equivalent to 1.7 cm of altitude change) from 300 to 1100 hPa (mbar)
   Air Quality, AQI range 0 to 500
   Accelerometer (Shock & Vibration) user specified gravity force limit which will be reported
   Light sensor, user specified lumens limit which will be reported
   Camera 0.3 Megapixels 640×480 CMOS Sensor Camera Module
Operation:
Monitors all sensor data at a user specified sampling rate down to once per minute, on board memory for a minimum of 16 weeks, or slower rate as specified by the user to conserve memory—enables longer storage times.
When sensor exceeds user selectable limits, the beacon automatically stores more data to capture the events
Sensor beacon communicates via Bluetooth (BLE) to a gateway device in order to transmit sensor data to remote server tracking system and to receive the user specified configuration parameters from a system user interface
Battery life:
Lasts up to 8 weeks running on two AA rechargeable Ni-MH batteries at −20° C., 3 weeks at −40° C. and 10 weeks at +20° C.

### Interpretation.

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or steps plus function elements in the claims appended to this specification are intended to include any structure, material, or act for performing the function in combination with other claimed elements as specifically claimed.

“Processor”, as used herein, refers to one or more electronic devices that is/are capable of reading and executing instructions stored on a memory to perform operations on data, which may be stored on a memory or provided in a data signal. Non-limiting examples of processors include devices referred to as microprocessors, microcontrollers, central processing units (CPU), and digital signal processors. The term “processor” includes a plurality of physically discrete, operatively connected devices despite use of the term in the singular.

“Memory”, as used herein, refers to a non-transitory tangible medium for storing information in a format readable by a processor, and/or instructions readable by a processor to implement an algorithm. Non-limiting types of memory include solid-state, optical, and magnetic computer readable media. The term “memory” includes a plurality of physically discrete, operatively connected devices despite use of the term in the singular. Instructions stored by a memory may be based on a plurality of programming languages known in the art, with non-limiting examples including the C, C++, Python, MATLAB, and Java programming languages. The memory stores instructions executable by the processor to implement one or more embodiments of the method of the present invention, as described below. The memory storing such instructions may be considered to be a computer program product of the present invention.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A system for tracking a shipment of goods, comprising a computer server system configured to connect with a gateway and receive data from a sensor beacon;
(a) wherein the gateway comprises a communication module configured to implement a short-range wireless communication protocol and to connect to the computer server system via a network such as the Internet, a GPS location module or a location identifier, and a processor and a memory, configured to implement a method of automatically connecting via the short range wireless communication to a sensor beacon when the sensor beacon comes within range, receiving data from the sensor beacon and relaying the sensor beacon identity and data to the computer server system; and
(b) wherein the sensor beacon comprises one or more sensors to gather environmental data, a communication module configured with the short range wireless communication protocol, a processor and a memory, configured to implement a method of periodically gathering and storing environmental data, automatically connect to the gateway when in proximity to the gateway, and transfer the stored data to the gateway together with a unique beacon identity tag.

2. The system of claim 1, wherein the short range wireless protocol is Bluetooth or LoRa, and/or the sensor beacon does not include GPS functionality.

3. The system of claim 1, wherein the one or more sensors comprises a temperature, humidity, atmospheric pressure, air quality, accelerometer, light sensor, camera or a gas sensor, or combinations thereof.

4. The system of claim 1, further comprising a short-range FM transmitter.

5. The system of claim 1, further comprising a unique identifying machine-readable optical code, such as a two-dimensional barcode.

6. The system of claim 1, wherein the sensor records data on a periodic basis or when the data exceeds a pre-determined threshold.

7. The system of claim 1 wherein the gateway is configured to determine the received signal strength or power level of the sensor beacon wireless communication, and optionally calculate a distance from the gateway to the sensor beacon based on the signal strength or power level.

8. The system of claim 1 which comprises an analytical tool for processing the data received from the sensor beacon.

9. A method of tracking a shipment of goods which includes a sensor beacon comprising one or more sensors to gather environmental data, a communication module configured with a short range wireless communication protocol, a processor and a memory, comprising the steps of:
(a) associating the sensor beacon with the shipment;
(b) automatically connecting the sensor beacon to a gateway with the short range wireless communication protocol, when the shipment comes into proximity with the gateway;
(c) determining the location of the shipment by determining the location of the gateway;
(d) transferring environmental data collected and stored by the sensor beacon to a remote server through the gateway.

10. A system for tracking a shipment of goods, comprising a sensor beacon comprising a short range FM transmitter and/or a Bluetooth transmitter configured to transmit a code which uniquely identifies the transmitter, and an FM and/or Bluetooth receiver configured to receive the code and to determine relative strength or power level of the transmission.

11. The system of claim 10 wherein the sensor beacon further comprises an optical code, such as a two-dimensional barcode, for uniquely identifying the sensor beacon.

12. The system of claim 10 wherein the sensor beacon further comprises a Radio Data Signal (RDS) transmitter.

13. The system of claim 10, wherein the FM receiver and/or Bluetooth receiver comprises a smart phone or electronic device comprising an FM receiver and/or Bluetooth receiver, and/or cellular data interface and/or WiFi network connection, and optionally a camera or image sensor.

14. The system of claim 10, wherein the gateway is configured to transmit the sensor beacon identity and location to a remote server.
